(19) United States
(12) Patent Application Publication
(10) Pub. No.: US 2016/0020621 A1
(43) Pub. Date: Jan. 21, 2016

(54) BIDIRECTIONAL VOLTAGE CONVERTER FOR MULTI-CELL SERIES BATTERIES

(71) Applicant: Intel Corporation, Santa Clara, CA (US)

(72) Inventors: ANIL BABY, Bangalore (IN); SATISH PRATHABAN, Bangalore (IN)

(73) Assignee: Intel Corporation, Santa Clara, CA (US)

(21) Appl. No.: 14/331,395

(22) Filed: Jul. 15, 2014

(51) Int. Cl. H02J 7/00

(52) U.S. Cl. CPC H02J 7/0013; H02J 7/007

(57) ABSTRACT

The present application is directed to a bidirectional voltage converter for multi-cell series batteries. A power module may comprise a battery including at least two cells and a converter module to generate a single-cell voltage and a two-cell series voltage from battery power while controlling charging and/or discharging of the cells to be at substantially the same rate. A converter module may comprise a first capacitor coupled across a first cell, a second capacitor coupled across a second cell and a third capacitor that may be flexibly coupled. When balancing charge and/or discharge rate, the third capacitor may be coupled across the second capacitor for a set on time and then coupled across the first capacitor for the set on time. A variable off time between couplings may be determined based on the difference between the voltage in the third capacitor and first capacitor.

### TECHNICAL FIELD

The present disclosure relates to device power, and more particularly, to a battery system that leverages the benefits of both single cell battery systems and two-cell series battery systems.

### BACKGROUND

As new wireless communication technology continues to emerge, so do the capabilities available in new mobile devices. Initially, mobile devices were limited to only conveying voice communications. However, mobile devices have evolved into multifaceted platforms that have become increasingly integrated into daily existence. For example, devices such as smart phones, tablet computers, etc. are now used to conduct a variety of activities that were previously limited to being performed in-person, via a wired Internet connection, etc. Examples of these activities may include, but are not limited to, interpersonal communications, business communications, personal or professional financial transactions, interactions with social media or professional networking resources, downloading, uploading and/or consumption of multimedia content, etc.

With an increased reliance on mobile platforms comes increased focus on the resources that allow mobile platforms to function. For example, good power performance may be an area of focus for users in the market to purchase a mobile device. A mobile device that offers all sorts of beneficial functionality may be useless if it always needs to be recharged. When considering a power solution for a mobile platform, designers are often forced to select an imperfect solution. For example, at least two possible configurations for mobile batteries include a single cell “1S” type battery or a dual cell “2S” battery including two cells coupled in series. Both solutions have advantages and disadvantages. For example, 1S cells have readily available power management integrated circuits (PMICs) and chipsets, compatible device equipment, charging equipment and do not require cell balancing. However, the emergence of new larger mobile devices (e.g., tablet computers) may require the integration of inefficient voltage boost technology. Alternatively, 2S batteries operate at higher voltage levels, and thus, can more readily meet the needs of larger and more-powerful devices. However, there are also a number of disadvantages to 2S batteries such as, for example, a lack of available power control solutions that necessitate inefficient kluges to make these batteries work with existing technology, more expensive chargers, cell balancing, etc.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example device comprising a bidirectional voltage converter for multi-cell series batteries in accordance with at least one embodiment of the present disclosure;

FIG. 2 illustrates an example configuration for a device usable in accordance with at least one embodiment of the present disclosure;

FIG. 3 illustrates an example battery and 1S to 2S converter module in accordance with at least one embodiment of the present disclosure;

FIG. 4 illustrates example operations for a battery cell charge and/or discharge balancing in accordance with at least one embodiment of the present disclosure;

FIG. 5 illustrates an example power monitoring module in accordance with at least one embodiment of the present disclosure; and

FIG. 6 illustrates example operations for battery monitoring in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present application is directed to a bidirectional voltage converter for multi-cell series batteries. In one embodiment, a power module in a device may comprise at least a battery including at least two cells and a converter module to generate a single-cell voltage and a two-cell series voltage based on energy provided by the battery cells while also controlling the charge and/or discharge of the cells to be at substantially the same rate. The converter module may comprise, for example, a first capacitor coupled across a first cell in the battery, a second capacitor coupled across a second cell in the battery and a third capacitor that may be flexibly coupled across either the first capacitor or the second capacitor based on the manipulation of transistor switches also in the power module. When balancing charge and/or discharge rate, the third capacitor may be coupled across the second capacitor for a set on time to charge the third capacitor, and then coupled across the first capacitor for the set on time. A variable off time between couplings may be determined based on the difference between the voltage in the third capacitor and first capacitor. Embodiments consistent with the present disclosure may also include a power monitoring module for determining battery charge.

In one embodiment, a power module for providing power to a device may comprise, for example, at least a battery and a converter module. The battery may include at least two battery cells coupled in series. The converter module may be coupled to at least the battery and may be to generate at least a single-cell voltage and a two-cell series voltage from the battery while controlling at least one of charging or discharging of the at least two battery cells to be at substantially the same rate.

In one embodiment, the at least two battery cells may comprise a first battery cell to provide energy for generating the single-cell voltage and a second battery cell to, combined with the first battery, provide energy for generating the two-cell series voltage. The converter module may comprise, for example, a first capacitor coupled across the first battery cell, a second capacitor coupled across the second battery cell and a third capacitor flexibly coupled across either the first capacitor or second capacitor, the coupling of the third capacitor being based on control circuitry in the converter module. The control circuitry may comprise, for example, at least one drive and control module to drive at least four transistor switches, the at least four transistor switches being configurable by the at least one drive and control module to cause the third capacitor to be coupled across the first capacitor, coupled across the second capacitor or coupled to ground. The at least four transistor switches may include at least one of n-channel or p-channel metal oxide semiconductor field effect transistors. The at least one drive and control module may be to, for example, cause the third capacitor to be coupled across the second capacitor for a fixed on time to charge the third capacitor, determine a variable off time, delay for the variable off time and cause the third capacitor to be coupled across the first capacitor for the fixed on time. In one embodiment, the third capacitor may be to convey charge from the second capacitor to the first capacitor to supplement current being provided by the first battery cell to loads being driven by the single-cell voltage. In another embodiment, the third capacitor may be to convey charge from the first capacitor to the second capacitor, the charge being provided from a charging module configured to provide a charging current based on the single-cell voltage. The at least one drive and control module being to determine a variable off time may comprise, for example, the at least one drive and control module being to cause the third capacitor to be coupled to a common ground with the first capacitor, determine a voltage of the first capacitor, determine a voltage for the third capacitor, determine a difference between the first capacitor voltage and the third capacitor voltage and determine the variable off time based on an inverse of an absolute value of the difference between the first capacitor voltage and the third capacitor voltage.

In the same or a different embodiment, the power module may further comprise at least one direct current to direct current converter module to convert the two-cell series voltage into at least one higher or lower voltage. The power module may further comprise, for example, at least one power management module to convert the single-cell voltage to at least one higher or lower voltage. The power module may further comprise, for example, a power monitoring module including at least a fuel gauge module and a resistor network having at least a first resistor and second resistor. The fuel gauge module may be to measure current being provided to single-cell voltage loads through the first resistor, measure current being provided to two-cell series voltage loads through the first and second resistors, determine at least one of average charge current or discharge current based on the measurement and generate at least one of charge level data or interrupts based on the current determination. An example method consistent with the present disclosure may comprise causing, in a converter module comprising at least a first capacitor coupled across a first battery cell, a second capacitor coupled across a second battery cell and a third capacitor flexibly coupled across at least the first capacitor or the second capacitor, the third capacitor to be coupled across the second capacitor for a fixed on time to charge the third capacitor, determining a variable off time, delaying for the variable off time and causing the third capacitor to be coupled across the first capacitor for the fixed on time.

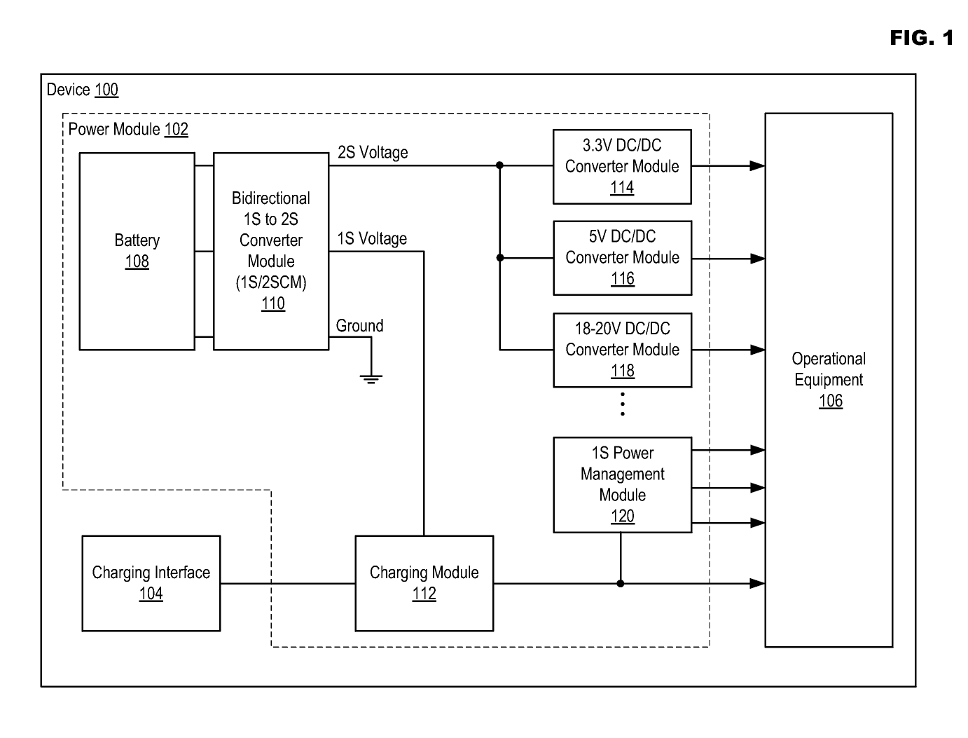

FIG. 1 illustrates an example device comprising a bidirectional voltage converter for multi-cell series batteries in accordance with at least one embodiment of the present disclosure. Device 100 may comprise at least power module 102 to receive power from charging interface 104 and to supply the power to operational equipment 106. Device 100 may be any device that may function without needing to receive power from an external power source. Examples of device 100 may comprise, but are not limited to, a mobile communication device such as a cellular handset, smartphone, etc. based on the Android® operating system (OS) from the Google Corporation, iOS® from the Apple Corporation, Windows® OS from the Microsoft Corporation, Mac OS from the Apple Corporation, Tizen™ OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle Fire® from the Amazon Corporation, etc., an Ultrabook® including a low-power chipset manufactured by Intel Corporation, a netbook, a notebook, a laptop, a palmtop, etc., a typically stationary computing device such as a desktop computer, a server, a smart television, small form factor computing solutions (e.g., for space-limited applications, TV set-top boxes, etc.) like the Next Unit of Computing (NUC) platform from the Intel Corporation, etc.

Power module 102 may include, for example, at least battery 108, bidirectional 1S to 2S converter module (1S/2SCM) 110, charging module 112 and a variety of modules 114-120 for generating different levels of voltage for supporting operational equipment 106 in device 100. In at least one embodiment, battery 108 may be a 2S battery comprising two cells coupled in series. While battery 108 has been disclosed herein as comprising only two cells, the use of a 2S battery herein is merely for the sake of explanation. Consistent with the present disclosure, battery 108 may comprise more than two cells based on, for example, the type, configuration, etc. of device 100. Returning to the example disclosed in FIG. 1, battery 108 being in a 2S configuration may be considered for larger and more powerful mobile devices (e.g., tablet computers), but typically would present challenges to designers such as the unavailability of low cost and compact PMICs, the need for 5V Universal Serial Bus (USB) chargers to incorporate a boost converter stage that results in higher cost and lower conversion efficiency, possibly a separate alternating current (AC) charging port that may increase the cost and decrease the aesthetics of device 100, separate buck converters and current limit switches for on-the-go (OTG) power generation, cell balancing, etc.

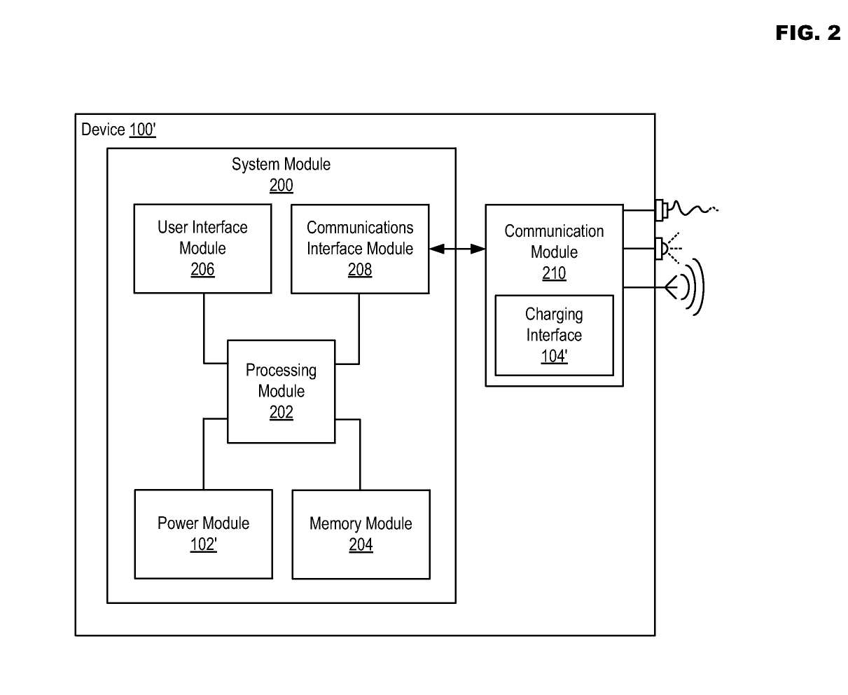

Consistent with the present disclosure, some or all of the above challenges to 2S battery use may be eliminated. 1S/2SCM 110 may be capable of generating both a 2S voltage (e.g., 6V to 8.7V) and a single cell (1S) voltage (e.g., 3V to 4.35V), and thus, may utilize existing PMICs configured to run on 1S voltage, may be charged by 1S battery chargers configured to integrate with existing USB technology, may automatically keep the cells balanced by balancing charge and/or discharge rate, etc. For example, charging interface 104 may receive power from a power source external to device 100 and may provide this power to charging module 112 that may proceed to generate a 1S voltage to 1S/2SCM 110. 1S/2SCM 110 may utilize the 1S voltage to equally charge both cells in battery 108. As further disclosed in FIG. 1, the 2S and 1S voltages may be provided to various converter modules, integrated circuits (ICs), chipsets, etc. Example converter modules may include, but are not limited to, 3.3V direct current (DC) to DC (DC/DC) converter module 114 that may convert the 2S voltage down to 3.3V, 5V DC/DC converter module 116 that may convert the 2S voltage down to 5V, 18-20V DC/DC converter module 118 that may convert the 2S voltage up to 18-20V, etc Likewise, charging module 112 may provide 1S voltage directly to operational equipment 106 and/or may drive at least one 1S power management module 120. 1S power management module 120 may comprise, for example, a PMIC or power management chipset configured to generate at least one rail voltage based on the 1S voltage. The type and/or number of converter modules and/or power management modules incorporated in power module 102 may depend on, for example, the requirements of operational equipment 106. Various examples of operational equipment 106 are described further in regard to device 100′ in FIG. 2.

FIG. 2 illustrates an example configuration for a device usable in accordance with at least one embodiment of the present disclosure. In particular, device 100′ may comprise equipment 106 that may be powered by power module 102 disclosed in FIG. 1. However, device 100′ is meant only as an example of an apparatus usable in embodiments consistent with the present disclosure, and is not meant to limit these various embodiments to any particular manner of implementation.

Device 100′ may comprise, for example, system module 200 configured to manage device operations. System module 200 may include, for example, processing module 202, memory module 204, power module 102′, user interface module 206 and communication interface module 208. Device 100′ may also include communication module 210 (e.g., with which charging interface 104′ may be associated). While communication module 210 has been illustrated as separate from system module 200, the example implementation shown in FIG. 2 has been provided herein merely for the sake of explanation. Some or all of the functionality associated with communication module 210 may be incorporated into system module 200.

In device 100′, processing module 202 may comprise one or more processors situated in separate components, or alternatively, one or more processing cores embodied in a single component (e.g., in a System-on-a-Chip (SoC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel

Corporation) configured to provide an interface through which processing module 202 may interact with other system components that may be operating at different speeds, on different buses, etc. in device 100′. Some or all of the functionality commonly associated with the support circuitry may also be included in the same physical package as the processor (e.g., such as in the Sandy Bridge family of processors available from the Intel Corporation).

Processing module 202 may be configured to execute various instructions in device 100′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) and/or read-only memory (ROM) in a fixed or removable format. RAM may include volatile memory configured to hold information during the operation of device 100′ such as, for example, static RAM (SRAM) or Dynamic RAM (DRAM). ROM may include non-volatile (NV) memory modules configured based on BIOS, UEFI, etc. to provide instructions when device 100′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

User interface module 206 may include hardware and/or software to allow users to interact with device 100′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, etc.) and various output mechanisms (e.g., speakers, displays, lighted/flashing indicators, electromechanical components for vibration, motion, etc.). The hardware in user interface module 206 may be incorporated within device 100′ and/or may be coupled to device 100′ via a wired or wireless communication medium. Communication interface module 208 may be configured to manage packet routing and other control functions for communication module 210, which may include resources configured to support wired and/or wireless communications. In some instances, device 100′ may comprise more than one communication module 210 (e.g., including separate physical interface modules for wired protocols and/or wireless radios) all managed by a centralized communication interface module 210. Wired communications may include serial and parallel wired mediums such as, for example, Ethernet, USB, Firewire, Digital Video Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), etc.), short-range wireless mediums (e.g., Bluetooth, WLAN, Wi-Fi, etc.), long range wireless mediums (e.g., cellular wide-area radio communication technology, satellite-based communications, etc.) or electronic communications via sound waves. In one embodiment, communication interface module 208 may be configured to prevent wireless communications that are active in communication module 210 from interfering with each other. In performing this function, communication interface module 208 may schedule activities for communication module 210 based on, for example, the relative priority of messages awaiting transmission. While the embodiment disclosed in FIG. 2 illustrates communication interface module 208 being separate from communication module 210, it may also be possible for the functionality of communication interface module 208 and communication module 210 to be incorporated into the same module.

Power module 102′ may be configured to receive power via charging interface 104′ and to then supply power for modules 200-210. In one embodiment, charging interface 104′ may be associated with communication module 210 because power may be received via a USB interface typically associated with conveying data. Since modules 200 to 210 may incorporate different types of technology, each module 200 to 210 may need to be supplied with one or more different operational voltages. For example, low power technologies may require 3.3V rails, while other components may require traditional 5V logic levels. Components in user interface module 106 may, for example, require 18-20V levels to power displays, backlights, etc. Again the variety of voltages needed in device 100′ may depend on, for example, the device type (e.g., smartphone, tablet computer, netbook, laptop, NUC, etc.), the functionality incorporated in device 100′, etc.

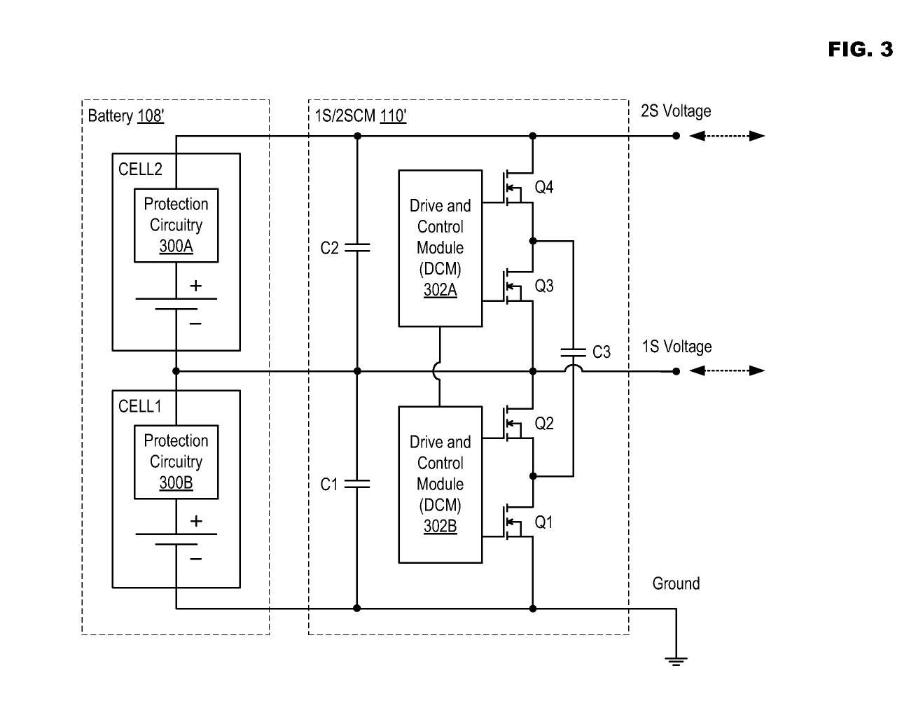

FIG. 3 illustrates an example battery and 1S to 2S converter module in accordance with at least one embodiment of the present disclosure. In on embodiment, battery 108′ may comprise, for example, at least two battery cells (e.g., CELL1 and CELL2) including protection circuitry 300A and 300B to protect CELL1 and CELL2, respectively, from damage due to overcharging, overcurrent, etc. While separate protection circuitry is illustrated for each cell, it is also possible to have a single set of generalized protection circuitry protecting all of battery 108′. CELL1 and CELL 2 may each be coupled to 1S/2SCM 110 to provide power for generating the 2S and 1S voltages. The 2S voltage, and resulting current to drive loads coupled to the 2S voltage, may be provided the combined charge of both CELL2 and CELL 1, while the 1S voltage and current to drive loads coupled to the 1S voltage are provided primary by CELL1. As a result, without any type of balancing the charge of CELL1 would be depleted faster than the charge of the CELL2.

1S/2SCM 110′ may comprise, for example, at least capacitors C1, C2 and C3, at least one drive and control module (DCM) 302 (e.g., in the disclosed embodiment, separate DCMs 302A and 302B are shown) and transistor switches Q1, Q2, Q3 and Q4 (collectively, “transistors Q1-Q4”). In one embodiment, transistors Q1-Q4 may be n-channel or p-channel metal oxide semiconductor field effect transistors (MOSFETS). In general, capacitors C1 and C2 may reflect the charge in CELL1 and CELL2, respectively, and capacitor C3 may act as a charge reservoir that “moves” between capacitors C1 and C2 to supplement the current being provided to 1S and 2S loads. The “moving” described above may involve DCM 302A and/or 302B causing transistors Q1-Q4 to couple capacitor C3 across capacitor C1, across capacitor C2, to ground, etc. Initially, capacitor C3 may be uncoupled when transistors Q1-Q4 are all off. DCM 302A and/or 302B may cause capacitor C3 to be coupled across capacitor C2 by turning on only transistors Q4 and Q2. DCM 302A and/or 302B may cause capacitor C3 to be coupled to ground by turning on only transistor Q1. DCM 302A and/or 302B may cause capacitor C3 to be coupled across capacitor C1 by turning on only transistors Q3 and Q1.

At least one benefit of 1S/2SCM 110′ is that it is bidirectional. During normal operation, charge may be transferred from CELL2 to CELL1 via capacitor C3 moving between capacitors C2 and C1 to supplement current provided by CELL1 to support 1S loads. Supplementing the 1S current in this manner may equalize the discharge rate of the CELL1 and CELL2. Moreover, further to utilizing a battery charger that may provide a 2S voltage to charge battery 108′, which may be a more expensive solution from the standpoint of the higher cost of the charger, the need for a dedicated charging port, etc., it now also becomes possible to use cheaper and more readily available 1S-type battery chargers. Capacitor C3 may convey charge from CELL1 to CELL2 in instances where, for example, charging module 112 provides a 1S charging current to CELL1. Consistent with the present disclosure, the configuration of 1S/2SCM 110′ allows charging and discharging to be done from the 1S and 2S voltage terminals simultaneously and independently.

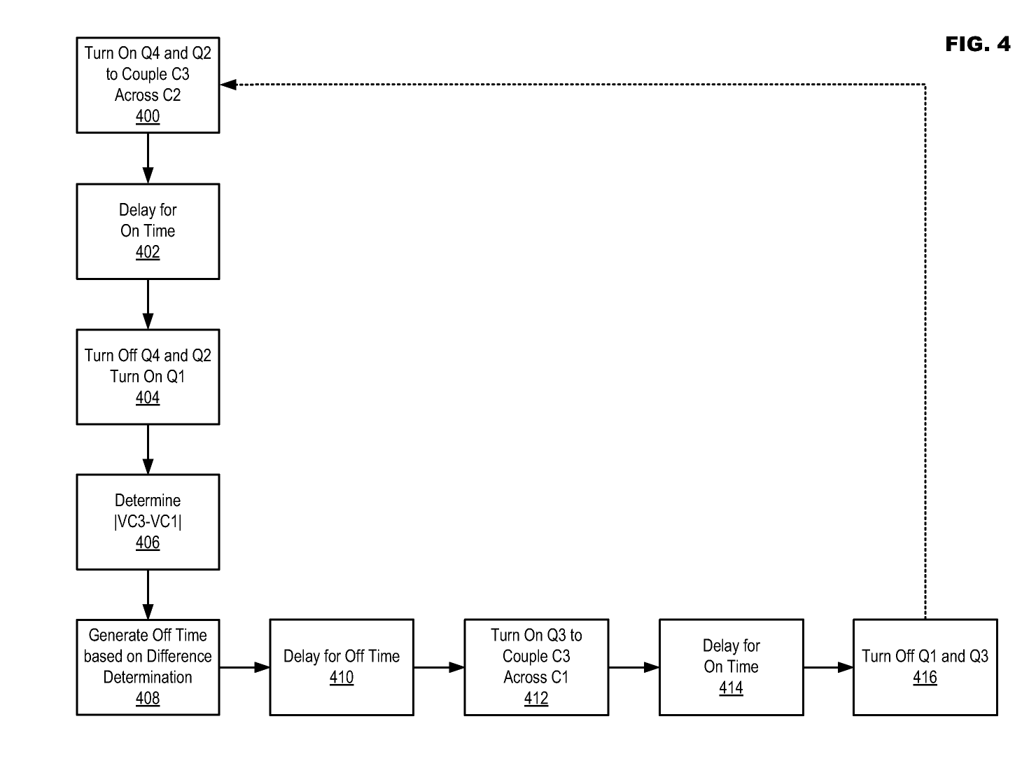

FIG. 4 illustrates example operations for a battery cell charge and/or discharge balancing in accordance with at least one embodiment of the present disclosure. Initially, DCM 302A and/or 302B may cause transistors Q4 and Q2 to turn on in operation 400, causing capacitor C3 to be coupled across capacitor C2 for an “on time” in operation 402. The on time may be set (e.g., fixed) in DCM 302A and/or 302B and may be determined based on, for example, the maximum average current required between the 2S and 1S terminals, the selected maximum switching frequency for moving capacitor C3 between capacitors C2 and C2, etc. Following the completion of the on time period in operation 402, transistors Q4 and Q2 may be turned off and transistor Q1 may be turned on to couple capacitor Q3 to a common ground with capacitor Q1 in operation 404. The absolute value of the difference between the voltage across capacitor C3 (e.g., VC3) and the voltage across capacitor C1 (e.g., VC1) may then be determined in operation 406 (e.g., IVC3-VC11). An “off time” may then be generated in operation 408, the off time being based on the inverse of this difference. Consistent with the present disclosure, the variable off time may control the rate at which capacitor C3 switches between capacitors C2 and C1. If the difference is large, the off time delay will be small and the switching rate will be higher, allowing charge to be transferred between C2 and C1 more quickly. Alternatively, a small difference will lead to a longer off time delay and a slower switching rate. Utilizing the absolute value of the difference allows the system to be bidirectional so that charge can be conveyed in either direction.

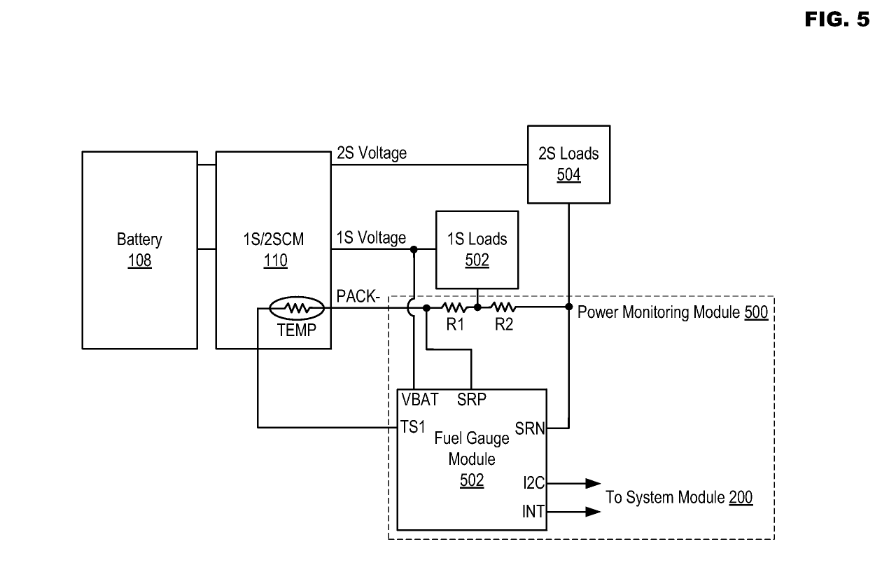

Following delaying for the off time in operation 410, DCM 302A and/or 302B may cause capacitor C3 to be coupled across capacitor C1 by turning on transistor Q3 (e.g., while transistor Q1 remains on) in operation 412. In one mode of operation, the coupling of capacitor C3 across capacitor C1 may supplement the current being provided by CELL1 to support load being driven by the 1S voltage using stored charge provided by CELL2. The coupling of capacitor C3 across capacitor C1 may remain for the duration of the on time in operation 414. Transistors Q1 and Q3 may then be turned off in operation 416, totally decoupling capacitor C3 from capacitor C1, capacitor C2 and ground. Consistent with the present disclosure, operation 416 may be followed by a return to operation 400 wherein operations 400 to 416 may resume with capacitor C3 again being coupled across capacitor C2. In an alternative mode of operation, this second coupling of capacitor C3 across capacitor C2 may convey stored charge from CELL1 to CELL2 when, for example, a charging current is being provided to the 1S terminal of CELL 1 by charging 112. FIG. 5 illustrates an example power monitoring module in accordance with at least one embodiment of the present disclosure. An example configuration for power module 102, as illustrated in FIG. 1, may necessitate a different current sense topology so that conventional fuel gauging ICs, chipsets, etc. may be employed. An example configuration for power monitoring module 500 is disclosed in FIG. 5. There are currents at two voltage levels that may be produced by 1S/2SCM 110: a 1S voltage and a 2S voltage level. Power monitoring module 500 will allow fuel gauge module 502 to see a 1S battery with 2 cells in parallel. A resistor network consisting of R1 and R2 may measure 2S currents across a combined resistance of R1 and R2 (e.g., 20 mΩ) and 1S currents across just the resistance of R1 (e.g., 10 mΩ). Fuel gauge module 502 may sense the sum of both the voltages to measure the total of currents from both CELL1 and CELL2. This configuration may measures the final average charge current or discharge current irrespective of the charge or discharge condition of either load. In an example of operation, fuel gauge module may measure the 1S voltage of battery 108 (e.g., VBAT), the battery temperature as provided by a TEMP thermistor in battery 108 (e.g., TS1), a battery current sense positive via a battery pack return path (e.g., PACK-) to fuel gauge module 502 (e.g., SRP) and a battery current sense negative to fuel gauge 502 (e.g., SRN). Based on these values, fuel gauge module 502 may generate battery charge data and transmit it on an interface bus (e.g., an I2C bus comprising at least clock (I2C_clock) and data (I2C_data) lines) and/or may generate interrupts (INT) to system module 200. System module 200 may utilize the data/interrupts to take action in device 100 including, for example, changing device operation to conserve energy, updating charge level indicators in device 100, initiating low power alerts in device 100, etc.

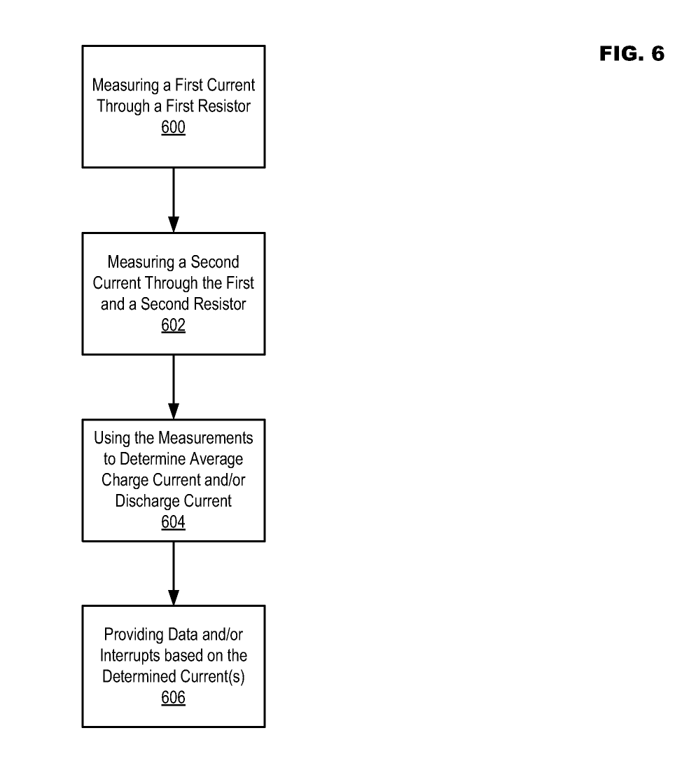

FIG. 6 illustrates example operations for battery monitoring in accordance with at least one embodiment of the present disclosure. In operation 600, a first current may be measured (e.g., by fuel gauge module 502) through a first resister (e.g., R1). A second current may then be measured through the first resistor and a second resistor (e.g., R2) in operation 602. The currents measured in operations 600 and 602 may then be used in operation 604 to determine at least one of average charge current and/or discharge current for battery 108. In operation 608, the average charge current and/or discharge current for battery 108 may be used to generate data and/or interrupts. The data and/or interrupts may be used by control resources in device 100 (e.g., system module 200) to control the operation of device 100, update indicators, issue alerts, etc.

While FIGS. 4 and 6 illustrate operations according to different embodiments, it is to be understood that not all of the operations depicted in FIGS. 4 and 6 are necessary for other embodiments. Indeed, it is fully contemplated herein that in other embodiments of the present disclosure, the operations depicted in FIGS. 4 and 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and

C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present application is directed to a bidirectional voltage converter for multi-cell series batteries. A power module may comprise a battery including at least two cells and a converter module to generate a single-cell voltage and a two-cell series voltage from battery power while controlling charging and/or discharging of the cells to be at substantially the same rate. A converter module may comprise a first capacitor coupled across a first cell, a second capacitor coupled across a second cell and a third capacitor that may be flexibly coupled. When balancing charge and/or discharge rate, the third capacitor may be coupled across the second capacitor for a set on time and then coupled across the first capacitor for the set on time. A variable off time between couplings may be determined based on the difference between the voltage in the third capacitor and first capacitor.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for bidirectional voltage converter for multi-cell series batteries, as provided below.

According to example 1 there is provided a power module for providing power to a device. The device may comprise a battery including at least two battery cells coupled in series and a converter module coupled to at least the battery, the converter module being to generate at least a single-cell voltage and a two-cell series voltage from the battery while controlling at least one of charging or discharging of the at least two battery cells to be at substantially the same rate.

Example 2 may include the elements of example 1, wherein, wherein the at least two battery cells comprise a first battery cell to provide energy for generating the single-cell voltage and a second battery cell to, combined with the first battery, provide energy for generating the two-cell series voltage.

Example 3 may include the elements of example 2, wherein at least one of the first battery cell and the second battery cell comprise protection circuitry.

Example 4 may include the elements of any of examples 1 to 3, wherein the converter module comprises a first capacitor coupled across the first battery cell, a second capacitor coupled across the second battery cell and a third capacitor flexibly coupled across either the first capacitor or second capacitor, the coupling of the third capacitor being based on control circuitry in the converter module.

Example 5 may include the elements of example 4, wherein the control circuitry comprises at least one drive and control module to drive at least four transistor switches, the at least four transistor switches being configurable by the at least one drive and control module to cause the third capacitor to be coupled across the first capacitor, coupled across the second capacitor or coupled to ground.

Example 6 may include the elements of example 5, wherein the at least four transistor switches include at least one of n-channel or p-channel metal oxide semiconductor field effect transistors.

Example 7 may include the elements of example 5, wherein the at least one drive and control module is to cause the third capacitor to be coupled across the second capacitor for a fixed on time, determine a variable off time, delay for the variable off time and cause the third capacitor to be coupled across the first capacitor for the fixed on time.

Example 8 may include the elements of example 7, wherein the third capacitor is to convey charge from the second capacitor to the first capacitor to supplement current being provided by the first battery cell to loads being driven by the single-cell voltage.

Example 9 may include the elements of example 7, wherein the third capacitor is to convey charge from the first capacitor to the second capacitor, the charge being provided from a charging module configured to provide a charging current based on the single-cell voltage.

Example 10 may include the elements of example 9, wherein the charging module receives power from a charging interface to generate a single cell voltage to charge at least the first battery cell.

Example 11 may include the elements of example 10, wherein the charging interface is also a communication interface.

Example 12 may include the elements of example 7, wherein the at least one drive and control module being to determine a variable off time comprises the at least one drive and control module being to cause the third capacitor to be coupled to a common ground with the first capacitor, determine a voltage of the first capacitor, determine a voltage for the third capacitor, determine a difference between the first capacitor voltage and the third capacitor voltage and determine the variable off time based on an inverse of an absolute value of the difference between the first capacitor voltage and the third capacitor voltage.

Example 13 may include the elements of example 12, wherein the at least one drive and control module is further to determine the fixed on time based on at least one of the maximum average current required between the two-cell series voltage and the single-cell voltage or a selected maximum switching frequency for moving the third capacitor between the first and second capacitors.

Example 14 may include the elements of any of examples 1 to 3, further comprising at least one direct current to direct current converter module to convert the two-cell series voltage into at least one higher or lower voltage.

Example 15 may include the elements of example 14, further comprising at least one power management module to convert the single-cell voltage to at least one higher or lower voltage.

Example 16 may include the elements of example 15, wherein at least one of the at least one direct current to direct current converter or the at least one power management module are to generate voltages for driving operational equipment in the device comprising the power module. Example 17 may include the elements of any of examples 1 to 3, further comprising a power monitoring module including at least a fuel gauge module and a resistor network having at least a first resistor and second resistor.

Example 18 may include the elements of example 17, wherein the fuel gauge module is to measure current being provided to single-cell voltage loads through the first resistor, measure current being provided to two-cell series voltage loads through the first and second resistors, determine at least one of average charge current or discharge current based on the measurement and generate at least one of charge level data or interrupts based on the current determination.

Example 19 may include the elements of any of examples 1 to 3, wherein the at least two battery cells comprise a first battery cell to provide energy for generating the single-cell voltage and a second battery cell to, combined with the first battery, provide energy for generating the two-cell series voltage, and the converter module comprises a first capacitor coupled across the first battery cell, a second capacitor coupled across the second battery cell and a third capacitor flexibly coupled across either the first capacitor or second capacitor, the coupling of the third capacitor being based on control circuitry in the converter module.

Example 20 may include the elements of any of examples 1 to 3, further comprising a power monitoring module including at least a fuel gauge module and a resistor network having at least a first resistor and second resistor, the fuel gauge module being to measure current being provided to single-cell voltage loads through the first resistor, measure current being provided to two-cell series voltage loads through the first and second resistors, determine at least one of average charge current or discharge current based on the measurement and generate at least one of charge level data or interrupts based on the current determination.

According to example 21 there is provided a method for controlling at least one of battery cell charge or discharge. The method may comprise causing, in a converter module comprising at least a first capacitor coupled across a first battery cell, a second capacitor coupled across a second battery cell and a third capacitor flexibly coupled across at least the first capacitor or the second capacitor, the third capacitor to be coupled across the second capacitor for a fixed on time to charge the third capacitor, determining a variable off time, delaying for the variable off time and causing the third capacitor to be coupled across the first capacitor for the fixed on time.

Example 22 may include the elements of example 21, wherein the third capacitor is conveying charge from the second capacitor to the first capacitor to supplement current being provided by the first battery cell to loads being driven by the single-cell voltage.

Example 23 may include the elements of any of examples 21 to 22, wherein the third capacitor is conveying charge from the first capacitor to the second capacitor, the charge being provided from a charging module configured to provide a charging current based on the single-cell voltage.

Example 24 may include the elements of any of examples 21 to 22, wherein determining a variable off time comprises causing the third capacitor to be coupled to a common ground with the first capacitor, determining a voltage of the first capacitor, determining a voltage for the third capacitor, determining a difference between the first capacitor voltage and the third capacitor voltage and determining the variable off time based on an inverse of an absolute value of the difference between the first capacitor voltage and the third capacitor voltage.

Example 25 may include the elements of example 24, and may further comprise determining the fixed on time based on at least one of the maximum average current required between the two-cell series voltage and the single-cell voltage or a selected maximum switching frequency for moving the third capacitor between the first and second capacitors.

Example 26 may include the elements of any of examples 21 to 22, and may further comprise measuring, in a power monitoring module including at least a fuel gauge module and a resistor network having at least a first resistor and second resistor, current being provided to single-cell voltage loads through the first resistor, measuring current being provided to two-cell series voltage loads through the first and second resistors, determining at least one of average charge current or discharge current based on the measurement and generating at least one of charge level data or interrupts based on the current determination.

According to example 27 there is provided a system including at least a device, the system being arranged to perform the method of any of the above examples 21 to 26.

According to example 28 there is provided a chipset arranged to perform the method of any of the above examples 21 to 26.

According to example 29 there is provided at least one machine readable medium comprising a plurality of instructions that, in response to be being executed on a computing device, cause the computing device to carry out the method according to any of the above examples 21 to 26.

According to example 30 there is provided a device configured with a bidirectional voltage converter for multi-cell series batteries, the device being arranged to perform the method of any of the above examples 21 to 26.

According to example 31 there is provided a system for controlling at least one of battery cell charge or discharge. The system may comprise means for causing, in a converter module comprising at least a first capacitor coupled across a first battery cell, a second capacitor coupled across a second battery cell and a third capacitor flexibly coupled across at least the first capacitor or the second capacitor, the third capacitor to be coupled across the second capacitor for a fixed on time to charge the third capacitor, means for determining a variable off time, means for delaying for the variable off time and means for causing the third capacitor to be coupled across the first capacitor for the fixed on time.

Example 32 may include the elements of example 31, wherein the third capacitor is conveying charge from the second capacitor to the first capacitor to supplement current being provided by the first battery cell to loads being driven by the single-cell voltage.

Example 33 may include the elements of any of examples 31 to 32, wherein the third capacitor is conveying charge from the first capacitor to the second capacitor, the charge being provided from a charging module configured to provide a charging current based on the single-cell voltage.

Example 34 may include the elements of any of examples 31 to 32, wherein the means for determining a variable off time comprise means for causing the third capacitor to be coupled to a common ground with the first capacitor, means for determining a voltage of the first capacitor, means for determining a voltage for the third capacitor, means for determining a difference between the first capacitor voltage and the third capacitor voltage and means for determining the variable off time based on an inverse of an absolute value of the difference between the first capacitor voltage and the third capacitor voltage.

Example 35 may include the elements of any of examples 31 to 32, and may further comprise means for measuring, in a power monitoring module including at least a fuel gauge module and a resistor network having at least a first resistor and second resistor, current being provided to single-cell voltage loads through the first resistor, means for measuring current being provided to two-cell series voltage loads through the first and second resistors, means for determining at least one of average charge current or discharge current based on the measurement and means for generating at least one of charge level data or interrupts based on the current determination.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A power module for providing power to a device, comprising:
a battery including at least two battery cells coupled in series; and
a converter module coupled to at least the battery, the converter module being to generate at least a single-cell voltage and a two-cell series voltage from the battery while controlling at least one of charging or discharging of the at least two battery cells to be at substantially the same rate.

2. The module of claim 1, wherein the at least two battery cells comprise a first battery cell to provide energy for generating the single-cell voltage and a second battery cell to, combined with the first battery, provide energy for generating the two-cell series voltage.

3. The module of claim 2, wherein the converter module comprises:
a first capacitor coupled across the first battery cell;
a second capacitor coupled across the second battery cell; and
a third capacitor flexibly coupled across either the first capacitor or second capacitor, the coupling of the third capacitor being based on control circuitry in the converter module.

4. The module of claim 3, wherein the control circuitry comprises at least one drive and control module to drive at least four transistor switches, the at least four transistor switches being configurable by the at least one drive and control module to cause the third capacitor to be coupled across the first capacitor, coupled across the second capacitor or coupled to ground.

5. The module of claim 4, wherein the at least four transistor switches include at least one of n-channel or p-channel metal oxide semiconductor field effect transistors.

6. The module of claim 4, wherein the at least one drive and control module is to:
cause the third capacitor to be coupled across the second capacitor for a fixed on time;
determine a variable off time;
delay for the variable off time; and
cause the third capacitor to be coupled across the first capacitor for the fixed on time.

7. The module of claim 6, wherein the third capacitor is to convey charge from the second capacitor to the first capacitor to supplement current being provided by the first battery cell to loads being driven by the single-cell voltage.

8. The module of claim 6, wherein the third capacitor is to convey charge from the first capacitor to the second capacitor, the charge being provided from a charging module configured to provide a charging current based on the single-cell voltage.

9. The module of claim 6, wherein the at least one drive and control module being to determine a variable off time comprises the at least one drive and control module being to:
cause the third capacitor to be coupled to a common ground with the first capacitor;
determine a voltage of the first capacitor;
determine a voltage for the third capacitor;
determine a difference between the first capacitor voltage and the third capacitor voltage; and
determine the variable off time based on an inverse of an absolute value of the difference between the first capacitor voltage and the third capacitor voltage.

10. The module of claim 1, further comprising at least one direct current to direct current converter module to convert the two-cell series voltage into at least one higher or lower voltage.

11. The module of claim 1, further comprising at least one power management module to convert the single-cell voltage to at least one higher or lower voltage.

12. The module of claim 1, further comprising a power monitoring module including at least a fuel gauge module and a resistor network having at least a first resistor and second resistor.

13. The module of claim 12, wherein the fuel gauge module is to:
measure current being provided to single-cell voltage loads through the first resistor;
measure current being provided to two-cell series voltage loads through the first and second resistors;
determine at least one of average charge current or discharge current based on the measurement; and
generate at least one of charge level data or interrupts based on the current determination.

14. A method for controlling at least one of battery cell charge or discharge, comprising:
causing, in a converter module comprising at least a first capacitor coupled across a first battery cell, a second capacitor coupled across a second battery cell and a third capacitor flexibly coupled across at least the first capacitor or the second capacitor, the third capacitor to be coupled across the second capacitor for a fixed on time to charge the third capacitor;
determining a variable off time;
delaying for the variable off time; and
causing the third capacitor to be coupled across the first capacitor for the fixed on time.

15. The method of claim 14, wherein the third capacitor is conveying charge from the second capacitor to the first capacitor to supplement current being provided by the first battery cell to loads being driven by the single-cell voltage.

16. The method of claim 14, wherein the third capacitor is conveying charge from the first capacitor to the second capacitor, the charge being provided from a charging module configured to provide a charging current based on the single-cell voltage.

17. The method of claim 14, wherein determining a variable off time comprises:
causing the third capacitor to be coupled to a common ground with the first capacitor;
determining a voltage of the first capacitor;
determining a voltage for the third capacitor;
determining a difference between the first capacitor voltage and the third capacitor voltage; and
determining the variable off time based on an inverse of an absolute value of the difference between the first capacitor voltage and the third capacitor voltage.

18. The method of claim 14, further comprising:
measuring, in a power monitoring module including at least a fuel gauge module and a resistor network having at least a first resistor and second resistor, current being provided to single-cell voltage loads through the first resistor;
measuring current being provided to two-cell series voltage loads through the first and second resistors;
determining at least one of average charge current or discharge current based on the measurement; and
generating at least one of charge level data or interrupts based on the current determination.

19. At least one machine-readable storage medium having stored thereon, individually or in combination, instructions that when executed by one or more processors result in the following operations for controlling at least one of battery cell charge or discharge, comprising:
causing, in a converter module comprising at least a first capacitor coupled across a first battery cell, a second capacitor coupled across a second battery cell and a third capacitor flexibly coupled across at least the first capacitor or the second capacitor, the third capacitor to be coupled across the second capacitor for a fixed on time to charge the third capacitor;
determining a variable off time;
delaying for the variable off time; and
causing the third capacitor to be coupled across the first capacitor for the fixed on time.

20. The medium of claim 19, wherein the third capacitor is conveying charge from the second capacitor to the first capacitor to supplement current being provided by the first battery cell to loads being driven by the single-cell voltage.

21. The medium of claim 19, wherein the third capacitor is conveying charge from the first capacitor to the second capacitor, the charge being provided from a charging module configured to provide a charging current based on the single-cell voltage.

22. The medium of claim 19, wherein the instructions for determining a variable off time comprise instructions that when executed by one or more processors result in the following operations, comprising:
causing the third capacitor to be coupled to a common ground with the first capacitor;
determining a voltage of the first capacitor;
determining a voltage for the third capacitor;
determining a difference between the first capacitor voltage and the third capacitor voltage; and
determining the variable off time based on an inverse of an absolute value of the difference between the first capacitor voltage and the third capacitor voltage.

23. The medium of claim 19, further comprising instructions that when executed by one or more processors result in the following operations, comprising:
measuring, in a power monitoring module including at least a fuel gauge module and a resistor network having at least a first resistor and second resistor, current being provided to single-cell voltage loads through the first resistor;
measuring current being provided to two-cell series voltage loads through the first and second resistors;
determining at least one of average charge current or discharge current based on the measurement; and
generating at least one of charge level data or interrupts based on the current determination.
